(19) United States
(12) Patent Application Publication
(10) Pub. No.: US 2004/0088256 A1
(43) Pub. Date: May 6, 2004

(54) Systems and methods for managing rates

(76) Inventors: Ralph Wilhelm Klein, Sherwood Park (CA); Leo Chan, Edmonton (CA)

Correspondence Address: FISH & NEAVE, 1251 AVENUE OF THE AMERICAS, 50TH FLOOR, NEW YORK, NY, 10020-1105, US

(21) Appl. No.: 10/287,556

(22) Filed: Nov. 1, 2002

(51) Int. Cl. G06F 17/60

(52) U.S. Cl. 705/40

(57) ABSTRACT

Systems and method for efficiently storing rate schedules and applying the rate schedules against operational events are provided. The rate schedules are represented in a database using a data structure that includes a field for storing a belief time during which the rate schedules are believed to be true. The database stores all versions of the rate schedules to ensure that complete audits of the rate schedules can be performed.

### BACKGROUND OF THE INVENTION

This invention relates generally to the management of employee wage rates. More specifically, the present invention relates to systems and methods for storing rates and applying the rates against operational events according to transaction rules.

Employee wages are monetary payments for labor or services provided, often according to a labor contract and on a hourly, daily, weekly, or other timely basis. Typically, the contract specifies that the employee wages are to be paid for a given time period and specifies the factors to be considered in determining the wages. Such factors may include overtime rates, employee benefits, experience level, job responsibility/function, employee qualifications, skills, taxes, and general economic conditions, among others. The contract may be an individual employment contract negotiated between the employer and the employee, or a collective bargaining agreement negotiated between the employer and a bargaining unit, formed by a group of employees represented by a labor union. In either case, wage rates may be subject to several changes in a given pay period, making it necessary for employers to keep track of all the rate changes in order to properly adjust employees' wages.

Wage rates are usually specified in a “rate schedule” included in the employment contract or bargaining agreement. A rate schedule is a timetable of rates applicable to an individual employee working for an organization or to a group of employees within the same occupation. In addition to the rates, a rate schedule may also specify transaction rules that govern the application of the rates against an operational event during a given time period. An operational event is an event that must be costed with a given rate, such as hours worked.

For example, the New York Department of Labor may have a rate schedule associated with workers employed by the city such as electricians, painters, carpenters, plumbers, and welders, among others. The rate schedule may list the hourly rates for each occupation according to experience level and time shifts, and may list the dates during which the rates are effective. An entry-level electrician working during the first day shift may be paid at a rate of $15/hour during the summer and at a rate of $18/hour during the winter. In another example, a management consulting firm may have a rate schedule that specifies the yearly rates for its associates, and the individual rates of each one of its partners.

Rate schedules are typically maintained by the payroll or labor departments of the organization enforcing the rates. These departments use the rate schedules to determine the wages payable to the organization's employees. The schedules may be provided by regulatory agencies, the organization's management, or bargaining units such as labor unions. A negotiation process between two or more of these parties usually takes place before finalizing a rate schedule for the payroll or labor departments.

Once a rate schedule is finalized and sent to the payroll or labor departments, it is typically entered into a payroll system. A payroll system is a software application for processing all information concerning an organization's payroll, including wages and benefits. The payroll system may be a standalone software application or a software module integrated into an accounting software package. Examples of payroll systems include Timberline Payroll, provided by Timberline Software Corporation, of Beaverton, Oreg., payroll modules of the StarBuilder software suite, provided by Geac Computer Corporation Ltd., of Ontario, Canada, J. D. Edwards payroll, provided by J. D. Edwards & Company, of Denver, Colo., Construction Management System's payroll application, provided by Computer Guidance Corporation, of Scottsdale, Ariz., Alerio Payroll, provided by Alerio Corporation, of Mission Viejo, Calif., and ABRA Payroll, provided by Best Software Limited, of Ontario, Canada.

To enter a rate schedule into a payroll system, a payroll department employee may manually enter the rates and dates in which the rates become effective into the system. This may be a daunting task when employment contracts and collective bargaining agreements change frequently during the course of a project or during an employee's term with the organization enforcing the rates, and, as a result, new rate schedules are created. The new rate schedules may specify new rates that are retroactive, thereby requiring the payroll systems to keep track of the retroactive rates and the dates in which they become effective in order to accurately process the organization's payroll. If the payroll system is not able to automatically track retroactive rate changes and changing employment contracts, computing the organization's payroll may become especially complex. Payroll adjustments may have to be manually performed, and the organization may have to spend a significant amount of time and resources training payroll department employees to properly compute retroactive rate adjustments.

Additionally, if the rate schedules apply to a large number of employees, keeping track of all the different rate schedules and effective dates may be difficult when the changes must be manually entered into the payroll system. In situations in which an error is made when entering a new rate and its associated effective date, the organization's payroll may be considerably affected for one or more pay periods. Furthermore, an error may be discovered only when an employee who is aware of the new rate and effective date receives a paycheck with an incorrect wage amount.

To catch data entry mistakes and to audit an organization's payroll, a payroll system must maintain a complete history of all the rates and rules and their effective dates. This may require that the organization store every possible combination of rates, rules, their associated effective dates, and the times and dates in which the information was entered into the organization's payroll system. However, this method is generally impractical due to the vast disk space required for maintaining a complete history of payroll data for large projects or organizations.

In view of the foregoing, it is an object of the present invention to provide systems and methods for efficiently storing wage rates.

It is a further object of the present invention to provide systems and methods for applying a rate schedule against operational events according to transaction rules.

It is also an object of the present invention to provide systems and methods for applying retroactive rate changes automatically to existing operational events.

### SUMMARY OF THE INVENTION

These and other objects of the invention are accomplished in accordance with the principles of the present invention by providing systems and methods for efficiently storing wage rates and applying the rates against operational events according to transaction rules. An operational event is an event that must be costed with one or more rates and is associated with a time, a resource, and a quantity. For example, an operational event may occur when Bob, a boilermaker, works 8 hours on Jun. 10, 2002.

The rates are specified in a rate schedule that lists the rates and the dates in which the rates are to become effective. The rates may also include transaction rules that govern the application of the rates against operational events, such as a rule that specifies a base salary for all labor personnel working in a given project. A transaction rule includes a database filter that describes the qualifying operational events and an effective schedule of rates that applies to the qualifying operational events. When a transaction rule is matched to a given operational event, an operational transaction that includes the operational event and the rates to be applied to the operational event is generated.

In a preferred embodiment, the system of the present invention may involve five main software components: (1) a rates cube data structure; (2) a database of rates, operational events, and rules; (3) a transaction rules manager; (4) a rates engine; and (5) a data access interface.

The rates cube data structure is a data structure for storing wage rates using three parameters: the dollar value of the rate in any suitable currency, the effective time in which the rate is to become effective, and a belief time. The belief time corresponds to a point in time when the dollar value of a rate and its associated effective time are believed to be true. For example, a rate schedule negotiated on Jan. 1, 2002, may specify that effective Apr. 1, 2002, a boilermaker is to be paid at an hourly rate of $20.00. On Feb. 1, 2002, the rate schedule is renegotiated and the hourly rate applicable to boilermakers starting on Apr. 1, 2002, is raised to $22.00. In this example, a belief time of Jan. 1, 2002 corresponds to a dollar value of $20.00 and an effective time of Apr. 1, 2002, and a belief time of Feb. 1, 2002 corresponds to a dollar value of $22.00 and an effective time of Apr. 1, 2002.

The rates cube data structure is used to store rate schedules in a rates table in a database. The rates table stores only the changes in values in the rates cube data structure to avoid storing every possible combination of rates, effective times, and belief times. Each entry in the rates table or change in values in the rates cube data structure is referred to as a “version.” A version specifies a rate according to a belief time interval, an effective time interval, and a dollar value of the rate.

Storing rate schedules as versions enables users to extract any time representation of a rate schedule, such as a current effective schedule that is effective as of today's date, a past effective schedule that was effective some time in the past, and a future effective schedule that is to become effective some time in the future. The use of versions also enables users to perform a complete audit of the rate schedules valid during any given time period by querying the rates table for all the versions that have belief time intervals corresponding to the time period in question.

In addition, the database stores the operational events to be costed against the rates in an operational events table. Each entry in the operational events table lists an operational event according to a belief time, an effective time, a resource, a resource type, and a quantity. The database also has a transaction rules table for storing the transaction rules that govern the application of rates to operational events.

The operational events in the operational events table are costed against applicable rates in the rates table by the rates engine. The rates engine runs a database filter to generate an operational transaction by matching a given entry in the operational events table to the rates in the rates table that are specified in the effective rate schedule of the transaction rule corresponding to the database filter. The rates engine also computes a dollar value for the operational transaction by applying the rates listed in the operational transaction to the operational event included in the transaction.

Transaction rules are specified through a transaction rules manager, which enables users to enter, edit, and access transaction rules. The transaction rules manager, rates, and operational events may all be accessed through a data access interface.

Advantageously, the systems and methods of the present invention enable organizations to efficiently store and apply rate schedules to operational events. In addition, the systems and methods of the present invention enable payroll department employees to automatically apply retroactive rate changes to existing operational events, and to perform complete audits of all rate schedules and operational events stored in the database.

### BRIEF DESCRIPTION OF THE DRAWINGS

The foregoing and other objects of the present invention will be apparent upon consideration of the following detailed description, taken in conjunction with the accompanying drawings, in which like reference characters refer to like parts throughout, and in which:

FIG. 1 is a schematic diagram of an exemplary environment in which the systems and methods of the present invention operate;

FIG. 2 is a schematic diagram of the software components used in accordance with the principles of the present invention;

FIG. 3 is a schematic diagram of the rates cube data structure;

FIG. 4 is an exemplary diagram of a time slice extracted from the rates cube data structure for a given belief time;

FIG. 5 is a schematic diagram of the fields used to represent a version in the rates table in the database;

FIG. 6 is an illustrative diagram showing a version A immediately before a version B in the rates table in the database;

FIG. 7 is an illustrative diagram showing a version A effectively before a version B in the rates table in the database;

FIG. 8 is a flow chart for adding a version in the rates table when the start effective time of the version is not in the effective time interval of any other version in the database;

FIG. 9 is an illustrative diagram showing a version B added to a rates table containing a version A effective after version B;

FIG. 10 is a flow chart for adding a version in the database when the start effective time of the version is in an effective time interval of another version in the database;

FIG. 11 is an illustrative diagram showing a version C added to a rates table containing a version A with an effective time interval that includes the effective time interval of version C;

FIG. 12 is a flow chart for adding a version in the database when the start effective time of the version is the same as the start effective time of another version in the database;

FIG. 13 is an illustrative diagram showing a new version B added to a rates table containing a version A with the same start effective time as version B;

FIG. 14 is a flow chart for removing a version from the rates table;

FIG. 15 is an illustrative diagram showing the removal of a version that is not effectively after any version on the current effective schedule;

FIG. 16 is an illustrative diagram showing the removal of a version B that is immediately after a version A on the current effective schedule;

FIG. 17 is a schematic diagram of the fields used to represent an operational event in the operational events table in the database;

FIG. 18 is an illustrative diagram showing an exemplary transaction rule;

FIG. 19 is an illustrative diagram showing an exemplary transaction; and

FIG. 20 is a flow chart for applying retroactive rates to existing transactions.

### DETAILED DESCRIPTION OF THE DRAWINGS

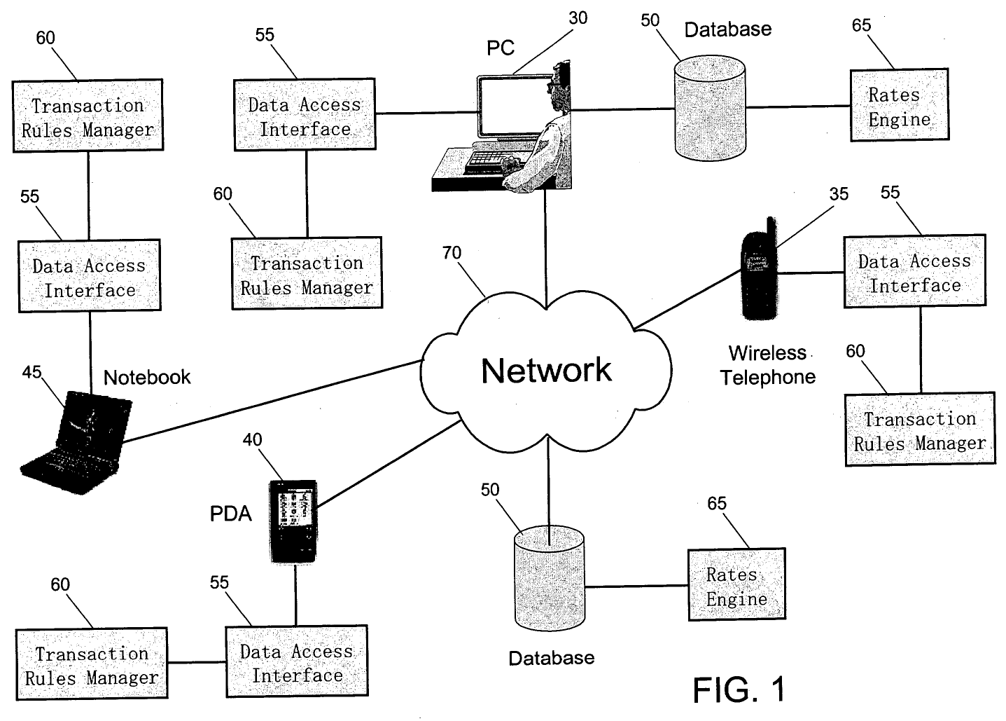

Referring to FIG. 1, a schematic diagram of an exemplary environment in which the systems and methods of the present invention operate is described. Database 50 is a database for storing rate schedules, transaction rules, and operational events for a given organization. A rate schedule is a timetable of rates applicable to operational events, or events associated with a time, resource, and a quantity representing a business operation. The rates in the rates schedule that apply to a given operational event are determined by one or more transaction rules. The organization may be a business, educational, governmental, or non-profit organization that applies the rate schedules against the operational events according to transaction rules for the purposes of computing its payroll, invoices, purchasing orders, or other monetarily valued resource employed for the organization.

For example, a rates schedule may list the hourly wage rates applicable to an organization's employee at different time periods: $10/hour during regular business hours and $12/hour for overtime. An operational event may list the employee working for 12 hours on Oct. 1, 2002, during the third business shift. A transaction rule may specify that employees working more than 8 hours a day during the third business shift should be paid at 3/2 their hourly rate for the first 8 hours and at 3/2 their overtime rate for the additional hours. Applying the transaction rule against the operational event and the rate schedule results in wages of $192 for the employee on Oct. 1, 2002.

Database 50 may be maintained locally by the organization, such as shown connected to PC 30, or it may be remotely accessed through network 70. Users authorized by the organization to enter, edit, access, or manage rate schedules, operational events, or transaction rules stored in database 50 may access database 50 through a number of appliances, including PC 30, wireless telephone 35, personal digital assistant 40, and notebook 45. Appliances 35-45 may access database 50 through data access interface 55.

Data access interface 55 may be used to enter, edit, and access rates, operational events, and transaction rules. Data access interface 60 includes transaction rules manager 55 for managing the transaction rules that govern the application of the rates to the operational events stored in database 50.

A transaction rule includes a database filter that describes the qualifying operational events and an effective schedule of rates that applies to the qualifying operational events in database 50. The database filter is run by rates engine 65. When a transaction rule is matched to a given operational event, an operational transaction including the operational event and the rates to be applied to the operational event is generated. Rates engine 65 also computes a dollar value for the operational transaction by applying the rates listed in the operational transaction to the operational event included in the transaction.

It should be understood by one skilled in the art that appliances 30-45 are shown for the purposes of illustration only and other appliances may be used to access database 50 through network 70.

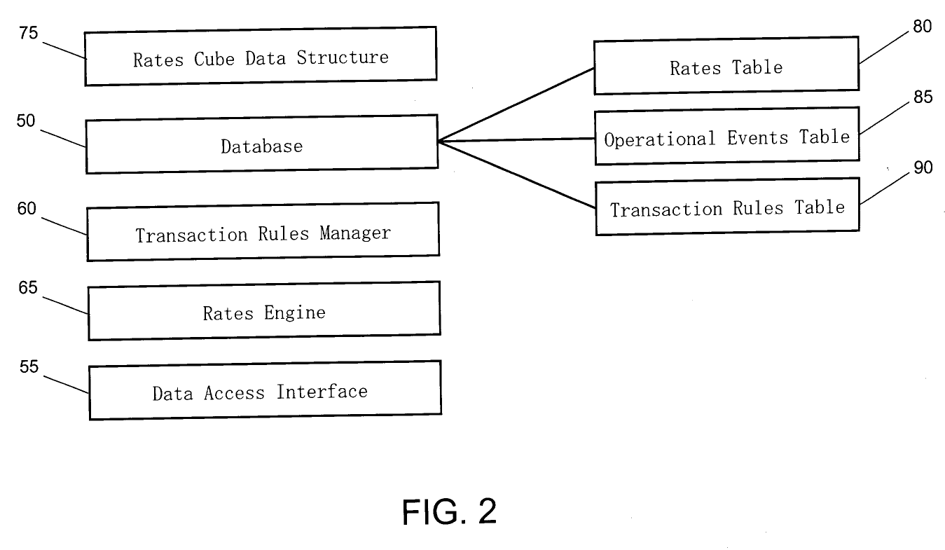

Referring now to FIG. 2, a schematic diagram of the software components used in accordance with the principles of the present invention is described. Rates cube data structure 75 is a data structure for storing rates using three parameters: the dollar value of the rate, the effective time in which the rate is to become effective, and a belief time. The belief time corresponds to a point in time when the dollar value of a rate and its associated effective time are believed to be true.

For example, a rate schedule negotiated on Jul. 1, 2002, may specify that effective Sep. 1, 2002, a public school teacher is to be paid at an hourly rate of $30.00. On Aug. 1, 2002, the rate schedule is renegotiated and the hourly rate applicable to public school teachers starting on Sep. 1, 2002, is raised to $33.00. In this example, a belief time of Jul. 1, 2002 corresponds to a dollar value of $30.00 and an effective time of Sep. 1, 2002, and a belief time of Aug. 1, 2002 corresponds to a dollar value of $33.00 and an effective time of Sep. 1, 2002.

Rates cube data structure 75 is used to store rate schedules in rates table 80 in database 50. Rates table 80 stores only the changes in values in rates cube data structure 75 to avoid storing every possible combination of rates, effective times, and belief times. Each entry in rates table 80 or change in values in rates cube data structure 75 is referred to as a “version”. A version specifies a rate according to a belief time interval, an effective time interval, and a dollar value of the rate.

Storing rate schedules as versions enables users to extract any time representation of a rate schedule, such as a current effective schedule that is effective as of today's date, a past effective schedule that was effective some time in the past, as well as a future effective schedule that is to become effective some time in the future. The versions also enable users to perform a complete audit of the rate schedules valid during any given time period by querying rates table 80 for all the versions that have belief time intervals corresponding to the time period in question.

Database 50 also stores the operational events to be costed against the rates in operational events table 85. Each entry in operational events table 85 lists an operational event according to a belief time, an effective time, a resource, a resource type, and a quantity. In addition, database 50 includes transaction rules table 90 for storing the transaction rules that govern the application of rates to operational events.

The operational events in operational events table 85 are costed against applicable rates in rates table 80 by rates engine 65. Rates engine 65 runs a database filter to generate an operational transaction by matching a given entry in operational events table 85 to the rates in rates table 80 specified in the transaction rule corresponding to the database filter. Transaction rules are stored in transaction rules table 90. Rates engine 65 also computes a dollar value for the operational transaction by applying the rates listed in the operational transaction to the operational event included in the transaction.

Transaction rules are specified through transaction rules manager 60, which enables users to enter, edit, and access transaction rules. Transaction rules manager 60, rates, and operational events may all be accessed through data access interface 55.

It should be understood by one skilled in the art that rates cube data structure 75, database 50, transaction rules manager 60, rates engine 65, and data access interface 55 may be implemented using different programming languages, operating systems, and hardware.

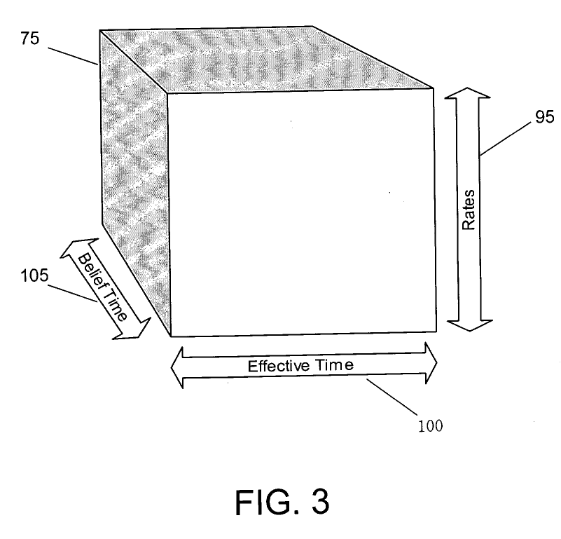

Referring now to FIG. 3, a schematic diagram of the rates cube data structure is described. Rates cube data structure 75 stores rate schedules using three fields: rate field 95, effective time 100, and belief time 105. Rate field 95 is a field for representing the dollar value of a set of rates, while effective time field 100 represents the time in which the rate is to become effective.

Belief time field 105 represents a point in time when the values of dollar value field 95 and effective time field 100 are believed to be true. For example, if an hourly wage rate of $10/hour effective on Jan. 1, 2002, is entered on database 50 on Dec. 20, 2001, and later modified on Dec. 31, 2001, to be $12/hour effective on Jul. 1, 2002, belief times between Dec. 20, 2001, and Dec. 31, 2001 assigned to belief time field 105 correspond to a value of $10 assigned to rate field 95 and a value of Jan. 1, 2002 assigned to effective time field 100.

Rates cube data structure 75 enables users to query any given point in time or time slice to extract the rates believed to be true on that point in time or time slice, or to extract the rates that are effective at that point in time or time slice.

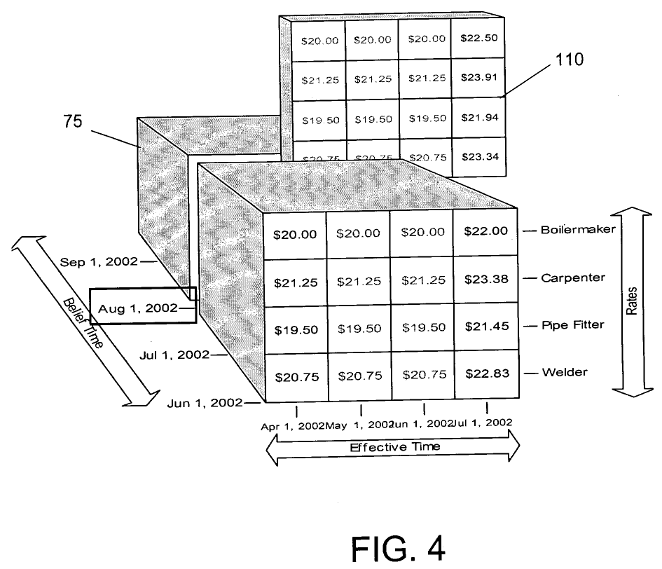

Referring now to FIG. 4, an exemplary diagram of a time slice extracted from the rates cube data structure for a given belief time is described. Time slice 110 illustrates a set of hourly wage rates applicable to boilermakers, carpenters, pipe fitters, and welders that are believed to be true on Aug. 1, 2002. Time slice 110 shows that the rates for these occupations were believed to be the same from Apr. 1, 2002, until Jul. 1, 2002, when a new set of rates became effective. For example, the hourly wage rate for a boilermaker was believed on Aug. 1, 2002, to be $20/hour effective on Apr. 1, 2002 and $22.50/hour effective on Jul. 1, 2002.

Using belief time field 105 in addition to rate field 95 and effective time field 100 to represent a rate schedule enables users to have an accurate and complete representation of the rate schedule entered in database 50. If an error is made when entering a rate schedule in database 50, users may query the values of belief time field 105 at a given time slice to discover when the error was made. Users may also query the values of belief time field 105 at a given time slice to know whether a rate should be applied retroactively.

For example, if time slices extracted between belief times of Jul. 1, 2002 and Aug. 1, 2002 reveal that during the month of July the hourly wage rate for a boilermaker was still believed to be $20/hour effective on Jul. 1, 2002 when the data slice extracted at a belief time of Aug. 1, 2002 reveals that on Aug. 1, 2002, the hourly wage rate for a boilermaker was believed to be $22.50/hour effective on Jul. 1, 2002, the payroll department in charge of paying the boilermakers may decide on Aug. 1, 2002, to apply $2.50/hour in retroactive rates for the month of July towards the boilermakers' pay. If the payroll department finds that the $22.50/hour rate was believed on Jul. 1, 2002 to become effective that day, the payroll department in charge of paying the boilermaker may find that a data entry mistake was made on Jul. 1, 2002 if the value of rate field 95 corresponding to an effective time of Jul. 1, 2002 was not properly updated on that day.

Rates cube data structure 75 is used to represent rate schedules in rates table 80 by storing only the changes in values in rate field 95, effective time field 100, and belief time field 105. Each entry in rates table 80 is referred to as a “version”. A version specifies a rate according to a belief time interval, an effective time interval, and a dollar value of the rate.

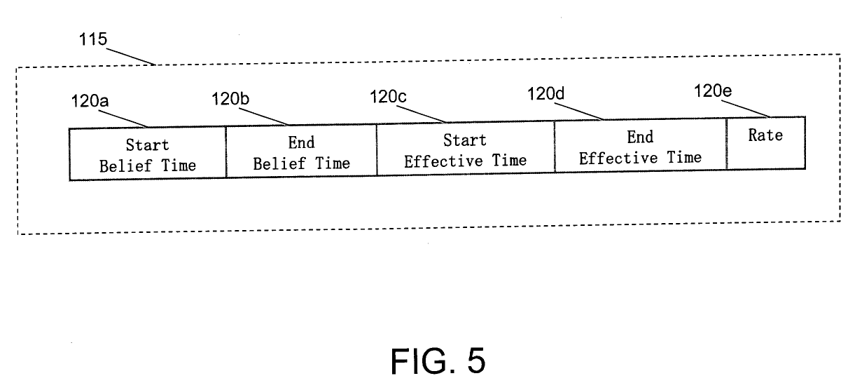

Referring now to FIG. 5, a schematic diagram of the fields used to represent a version in the rates table in the database is described. Version 115 represents an entry in rates table 80 in database 50. Version 115 includes five fields: (1) start belief time field 120a; (2) end belief time field 120b; (3) start effective time field 120c; (4) end effective time field 120d; and (5) rate field 120e.

Start belief time field 120a and end belief time field 120b represent the limits of a belief time interval, i.e., a period of time in which the values of fields 120c-e of version 115 are believed to be true. A time t is in the belief time interval of version 115 if time t is greater than or equal to version 115's value for start belief time field 120a and if time t is strictly less than version 115's value for end belief time field 120b.

For example, if start belief time field 120a has a value of Jul. 1, 2002, and end belief time field 120b has a value of Aug. 1, 2002, any time t between Jul. 1, 2002, and Aug. 1, 2002, is in the belief time interval of version 115. That is, the values of fields 120c-e of version 115 are believed to be true during the month of July.

In case the belief time interval is used to represent a time period that starts at start belief time 120a but has no set termination date, then the value of end belief time 120b is set to a special symbol denoting infinity. A value of infinity for end belief time field 120b indicates that for any time t, t is strictly less than infinity and that the values of fields 120c-e are believed to be true any time at and after the value of start belief time field 120a.

For example, if start belief time field 120a has a value of Jul. 1, 2002, and end belief time field 120b has a value of infinity, any time t after Jul. 1, 2002, is in the belief time interval of version 115, including current and future values of time t. That is, the values of fields 120c-e of version 115 are the values currently believed to be true as of Jul. 1, 2002, and any time after Jul. 1, 2002.

Start effective time field 120c and end effective time field 120d represent the limits of an effective time interval, i.e., a period of time in which the value of rate field 120d is effective. Rate field 120d represents the dollar value of a rate that is effective between start effective time field 120c and end effective time field 120d and believed to be true between start belief time field 120a and end belief time field 120b.

A time t is in the effective time interval of version 115 if time t is greater than or equal to version 115's value for start effective time field 120c and if time t is strictly less than version 115's value for end effective time field 120d. For example, if start effective time field 120c has a value of Oct. 1, 2002, and end effective time field 120d has a value of Dec. 1, 2002, any time t between Oct. 1, 2002, and Dec. 1, 2002, is in the effective time interval of version 115. That is, the value of rate field 120e is effective during the months of October and November.

Similarly to end belief time field 120b, end effective time field 120d is assigned a value of infinity when the effective time interval is used to represent a time period that starts at start effective time 120c but has no set termination date. That is, the value of rate field 120e is effective as of and any time after the value of start effective time field 120c.

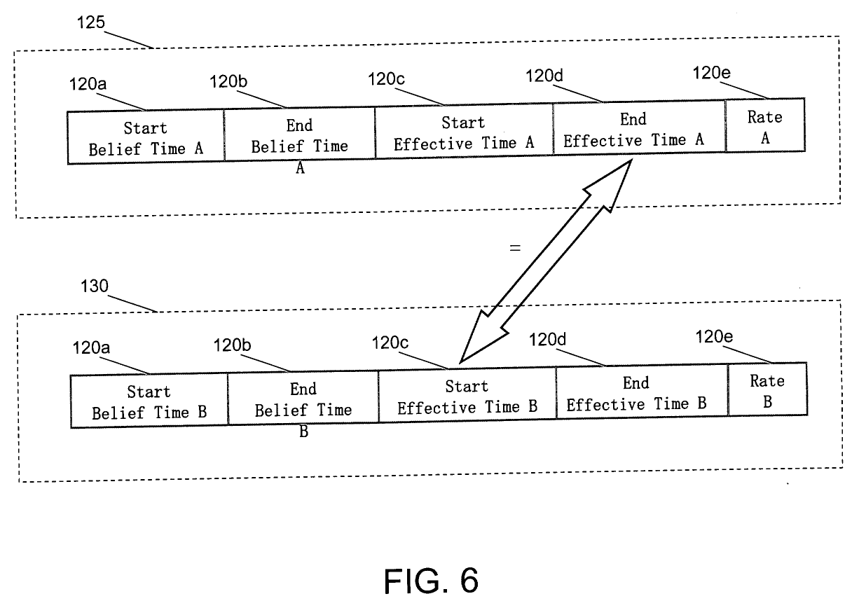

Referring now to FIG. 6, an illustrative diagram showing a version A immediately before a version B in the rates table in the database is described. Version A (125) is immediately before version B (130) in rates table 80 in database 50 when for a belief time t, t in the belief time interval of version A (125) and t in the belief time interval of version B (130), version A's (125) end effective time (120d) is equal to version B's (130) start effective time (120c). Conversely, version B (130) is immediately after version A (125).

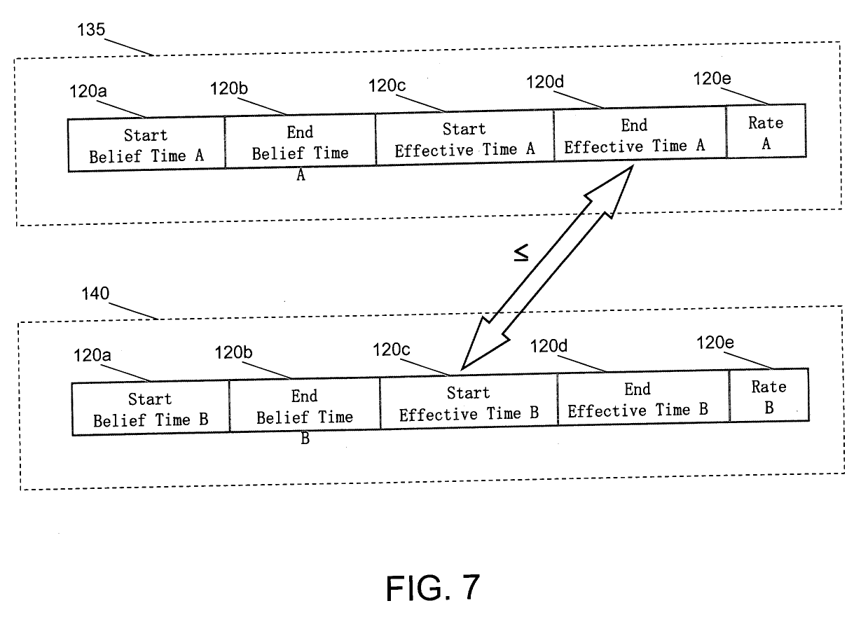

Referring now to FIG. 7, an illustrative diagram showing a version A effectively before a version B in the rates table in the database is described. Version A (135) is effectively before version B (140) in rates table 80 in database 50 when for a belief time t, t in the belief time interval of version A (135) and t in the belief time interval of version B (140), version A's (135) end effective time (120d) is less than or equal to version B's (140) start effective time (120c). Conversely, version B (140) is effectively after version A (135).

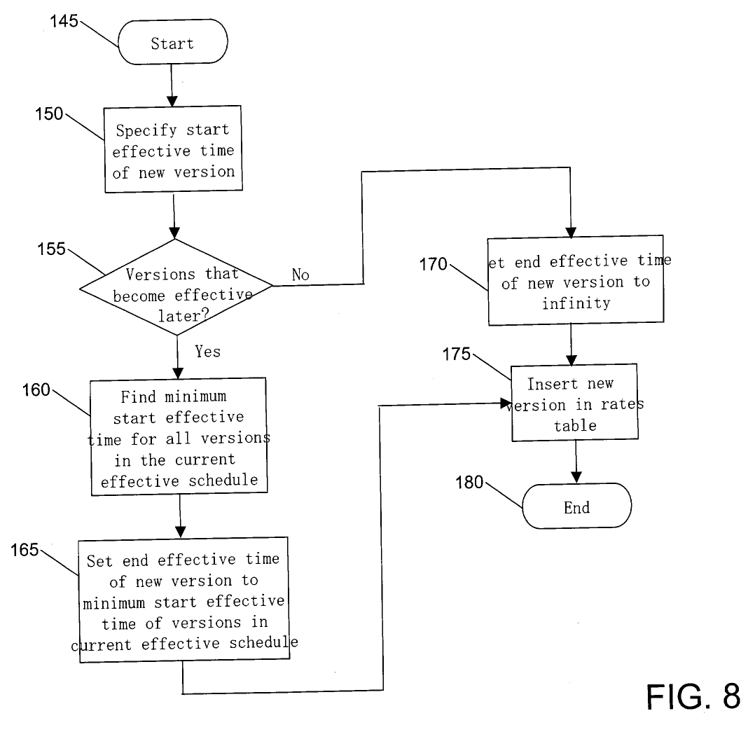

Referring now to FIG. 8, a flow chart for adding a version in the rates table when the start effective time of the version is not in the effective time interval of any other version in the database is described. At step 150, the user accesses data access interface 55 to specify the start effective time of the new version to be added to rates table 80 in database 50. If the start effective time of the new version is not in the effective time interval of any other existing version in rates table 80, then the end effective time of the new version is determined.

At step 155, rates table 80 is searched to determine whether there are any existing versions in rates table 80 that have become effective after the new version, that is, that have a start effective time strictly greater than the start effective time of the new version. If there is an existing version that becomes effective after the new version, then the minimum start effective time of all existing versions in rates table 80 that become effective after the new version is found at step 160. The end effective time of the new version is then set to the minimum start effective time of the existing versions that become effective after the new version at step 165. If there are no existing version in rates table 80 that becomes effective after the new version, then the end effective time of the new version is set to infinity at step 170. The new version is inserted into rates table 80 at step 175.

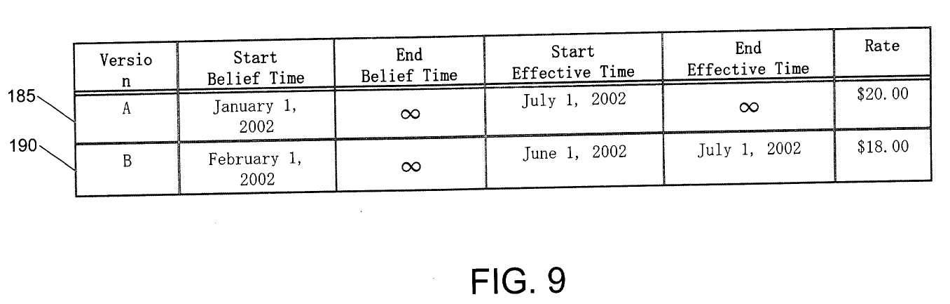

Referring now to FIG. 9, an illustrative diagram showing a version B added to a rates table containing a version A effective after version B is described. Version A (185) is a version in rates table 80 believed since Jan. 1, 2002 to become effective as of Jul. 1, 2002 with a rate of $20.00, that is, its belief time interval is from Jan. 1, 2002 until infinity, and its effective time interval is from Jul. 1, 2002 until infinity. On Feb. 1, 2002, a user discovers that a rate of $18.00 that was supposed to be enforced as of Jun. 1, 2002 was not entered in rates table 80. Since version A (185) is to become effective on Jul. 1, 2002, new version B (190) is added to rates table 80 having a start effective time of Jun. 1, 2002, and an end effective time of Jul. 1, 2002.

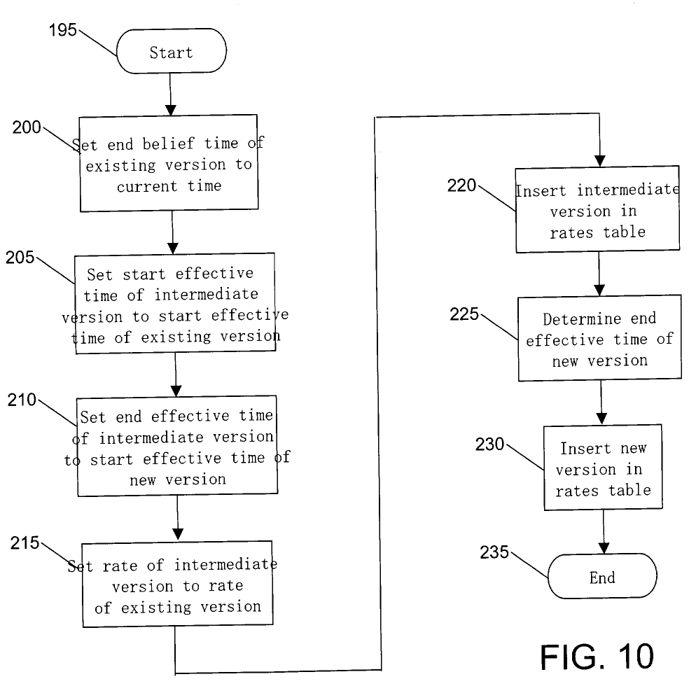

Referring now to FIG. 10, a flow chart for adding a version in the database when the start effective time of the version is in an effective time interval of another version in the database is described. To insert a new version in rates table 80 that becomes effective during the effective time interval of an existing version in rates table 80 requires the effective time interval of the existing version to be split in two. This is done by inserting an intermediate version in rates table 80 with an effective time interval starting at the start effective time of the existing version and ending at the start effective time of the new version.

First, at step 200, the end belief time of the existing version is set to the current time to indicate that the effective time interval of the existing version was believed to be valid only until the insertion of the new version in rates table 80.

Then, at steps 205, 210, and 215, the intermediate version's fields are assigned the following values: the start effective time field of the intermediate version is set to the start effective time of the existing version (205), the end effective time field of the intermediate version is set to the start effective time of the new version (210), and the rate field of the intermediate field is set to the rate of the existing version (215). The intermediate version is inserted into rates table 80 at step 220. At step 225, the end effective time of the new version is determined according to the steps described above in reference to FIG. 8. Finally, at step 230, the new version is inserted into rates table 80.

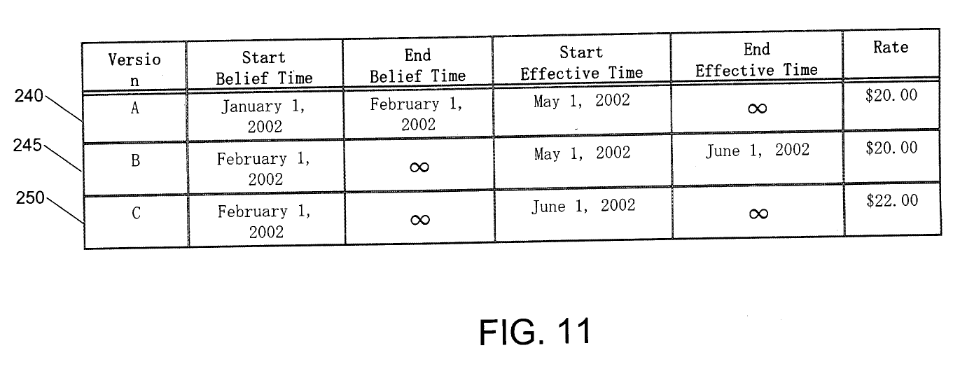

Referring now to FIG. 11, an illustrative diagram showing a version C added to a rates table containing a version A with an effective time interval that includes the effective time interval of version C is described. Version A (240) is a version in rates table 80 believed since Jan. 1, 2002 to become effective as of May 1, 2002 with a rate of $20.00, that is, its belief time interval is from Jan. 1, 2002 until infinity, and its effective time interval is from May 1, 2002 until infinity. On Feb. 1, 2002, a new rate schedule effective as of Jun. 1, 2002 reflecting a rate of $22.00 is to be recorded into rates table 80. The new rate schedule is recorded by inserting intermediate version B (245) and new version C (250) into rates table 80. Version B(245) is inserted to reflect that the effective time interval of version A (240) is now believed to have had a limited time duration. Version B (245) is inserted with a belief time interval starting on Feb. 1, 2002, and an effective time interval starting at the start effective time of version A (240) and ending at the start effective time of the new version C (250). The rate of intermediate version B (245) is set to the rate of existing version A (240).

New version C (250) is then inserted with a belief time interval starting on Feb. 1, 2002, an effective time interval starting on Jun. 1, 2002, and a rate of $22.00. Existing version A (240) is kept in rates table 80 even though it has a belief time interval of a limited time duration. Maintaining the existing versions in rates table 80 enables users to collect historical data for any time period and perform a full audit of all rate schedules entered in rates table 80.

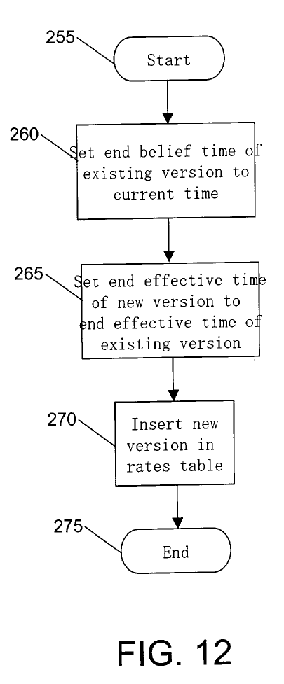

Referring now to FIG. 12, a flow chart for adding a version in the database when the start effective time of the version is the same as the start effective time of another version in the database is described. First, at step 260, the end belief time of the existing version is set to the current time. Second, at step 265, the end effective time of the new version is assigned the same value as the end effective time of the existing version. Lastly, at step 270, the new version is inserted in rates table 80.

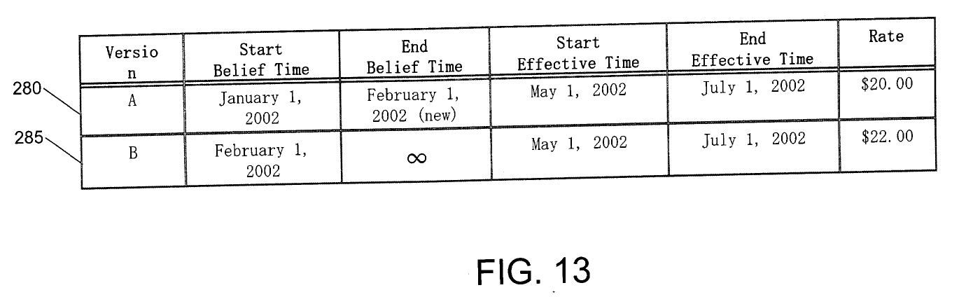

Referring now to FIG. 13, an illustrative diagram showing a new version B added to a rates table containing a version A with the same start effective time as version B is described. Version A (280) is a version in rates table 80 believed since Jan. 1, 2002 to be effective from May 1, 2002 to Jul. 1, 2002, with a rate of $20.00, that is, its belief time interval is from Jan. 1, 2002 until infinity, and its effective time interval is from May 1, 2002 until Jul. 1, 2002. On Feb. 1, 2002, the rate schedule is updated to reflect a new rate of $22.00 effective from May 1, 2002 to Jul. 1, 2002. To reflect the new rate, the end belief time of version A (280) is changed to Feb. 1, 2002, and version B (285) is inserted into rates table 80.

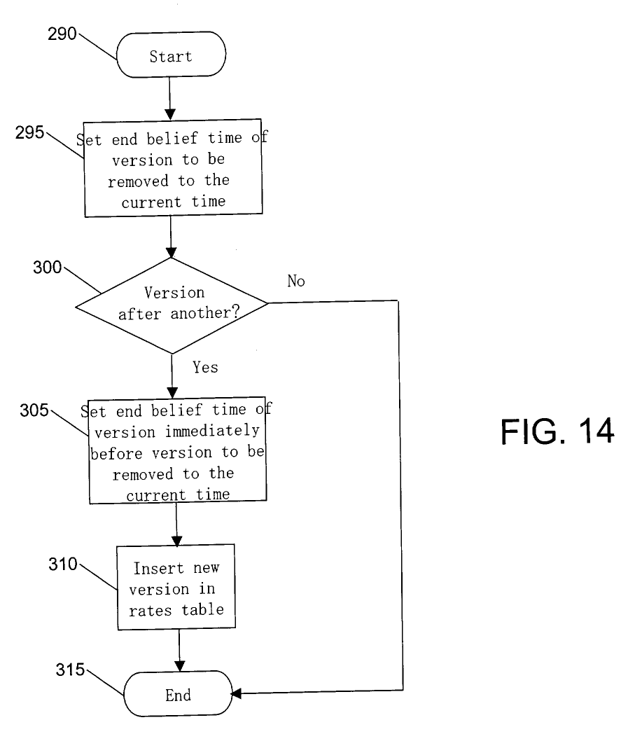

Referring now to FIG. 14, a flow chart for removing a version from the rates table is described. Removing a version from rates table 80 does not delete the version record in rates table 80; rather, it simply updates it to reflect that the version to be removed is no longer believed to be true. A version may be removed when a correction to the version is necessary.

At step 295, the end belief time of the version to be removed is set to the current time to reflect that the version is no longer believed to be true. If the version is immediately after another version in rates table 80 (300), then at step 305, the end belief time of the version immediately before the version being removed is set to the current time. A new version is inserted in rates table 80 to span the effective time for the version being removed and the version immediately preceding it and to reflect the change being made in rates table 80 that led to the version removal.

It should be understood by one skilled in the art that more than one version may be inserted into rates table 80 upon the removal of a version from rates table 80. New versions may be inserted into rates table 80 according to the steps described above with reference to FIGS. 8, 10, or 12.

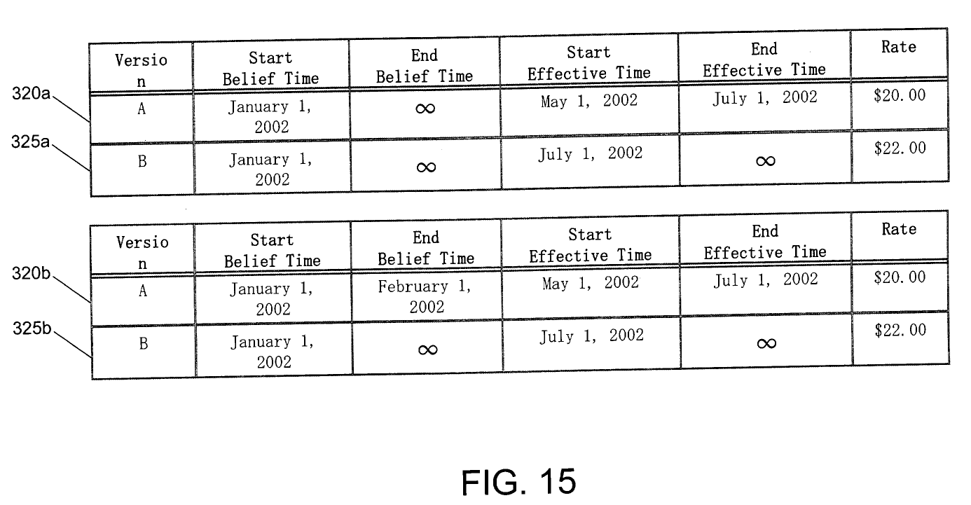

Referring now to FIG. 15, an illustrative diagram showing the removal of a version that is not effectively after any version on the current effective schedule is described. Rates table 80 has version A (320a) believed to be true as of Jan. 1, 2002, and specifying a rate of $20.00 effective between May 1, 2002 and Jul. 1, 2002. Rates table 80 also has version B (325a) believed to be true as of Jan. 1, 2002, and specifying a rate of $22.00 starting on Jul. 1, 2002. On Feb. 1, 2002, a correction is made to rates table 80 and version A (320a) is removed. The removal is reflected on the new end belief time of Feb. 1, 2002, in version A (320b).

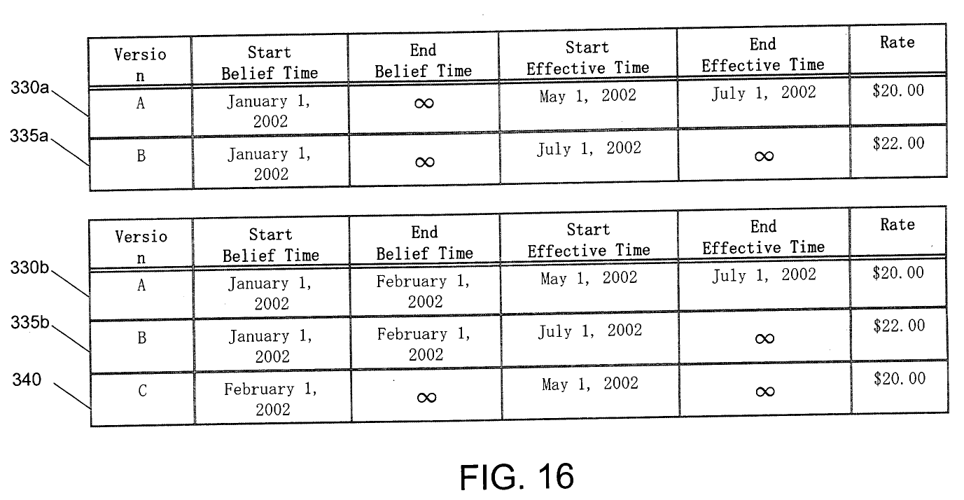

Referring now to FIG. 16, an illustrative diagram showing the removal of a version B that is immediately after a version A on the current effective schedule is described. Rates table 80 has version A (320a) believed to be true as of Jan. 1, 2002, and specifying a rate of $20.00 effective between May 1, 2002 and Jul. 1, 2002. Rates table 80 also has version B (325a) believed to be true as of Jan. 1, 2002, and specifying a rate of $22.00 starting on Jul. 1, 2002.

On Feb. 1, 2002, a correction is made to rates table 80 and version B (335a) is removed to update the rate effective as of Jul. 1, 2002 to be $20.00 instead of $22.00. The removal is reflected on the new end belief time of Feb. 1, 2002, in version B (335b). Since version A (330a) is immediately before version B (335a) in rates table 80, removing version B (335b) means that version A (330b) is no longer believed to be true and that the end belief time of version A (330b) is changed to Feb. 1, 2002. Lastly, version C (340) is inserted into rates table 80 to show that a rate of $20.00 was to be effective as of May 1, 2002 with no set termination period.

It should be understood by one skilled in the art that the steps performed with reference to FIGS. 8, 10, 12, and 14 may be performed in a different order and that additional steps may be used to insert, modify, or remove versions from rates table 80.

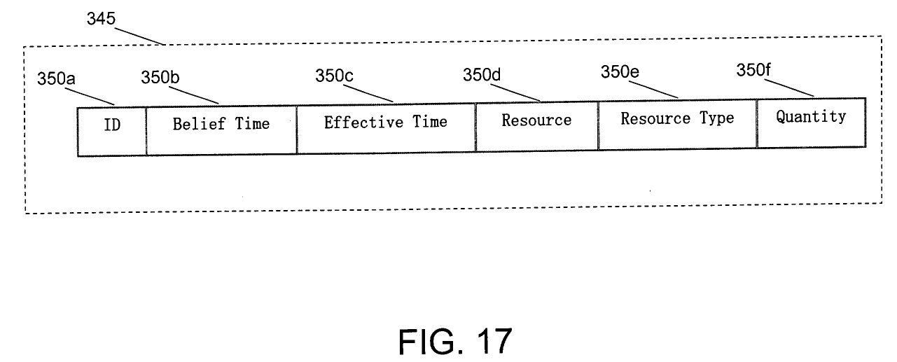

Referring now to FIG. 17, a schematic diagram of the fields used to represent an operational event in the operational events table in the database is described. Operational event 345 represents an entry in operational events table 85 in database 50. Operational event 345 is represented by six fields: (1) ID field 350a; (2) belief time field 350b; (3) effective time field 350c; (4) resource field 350d; (5) resource type field 350e; and (6) quantity field 350f.

ID field 350a is an identification field to uniquely identify operational event 345 in operational events table 85. ID field 350a may contain a text, number, or alphanumeric ID of operational event 345, such as an index listing the order in which operational event 350 was entered into operational events table 85.

Belief time field 350b indicates the time from which operational event 345 is believed to be true, which is the same as the time operational event 345 was entered into operational events table 85. Effective time field 350c indicates the time operational event 345 actually happened. Resource field 350d indicates the resource involved in performing operational event 345 while resource type field 350e indicates the type of resource used to perform operational event 345. Lastly, quantity field 350f represents the duration of the event.

For example, operational event 345 may be entered into operational events table 85 on Jul. 1, 2002 (belief time) to indicate that on Jun. 1, 2002 (effective time), Paul (resource), a consultant (resource type), worked 8 (quantity) hours. In another example, operational event 345 may be entered into operational events table 85 on Oct. 1, 2002 (belief time) to indicate that on Oct. 2, 2002 (effective time), mainframe 2 (resource), an equipment (resource type) rented at a given rate, is to be used for 5 (quantity) hours.

It should be understood by one skilled in the art that operational events may be entered into operational events table 85 at any effective time, including future times for operational events yet to happen.

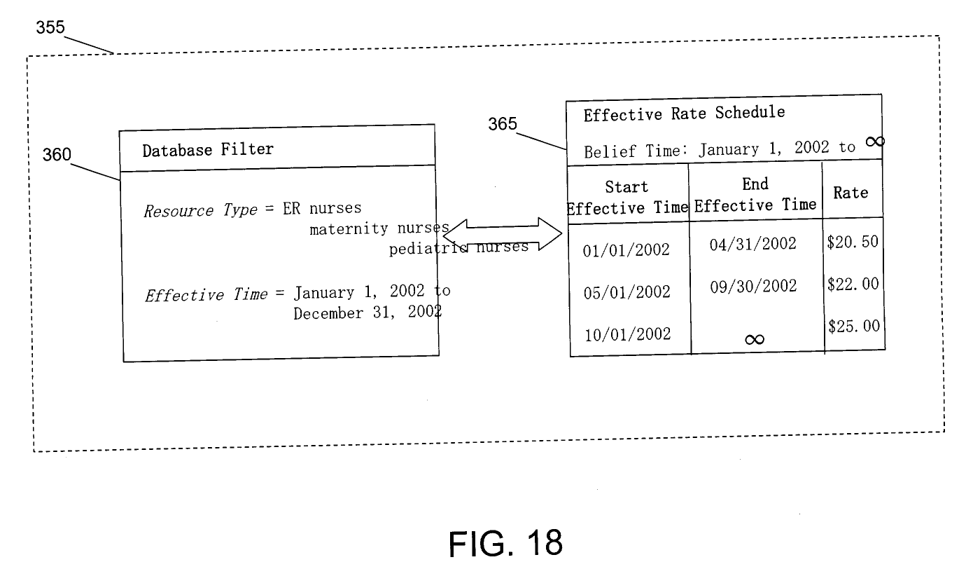

Referring now to FIG. 18, an illustrative diagram showing an exemplary transaction rule is described. A transaction rule includes a database filter to specify qualifying operational events and an effective schedule of rates to be applied to the qualifying operational events specified in the database filter. A database filter is a routine for searching operational events table 85 and returning only the qualifying operational events. For example, a database filter may be implemented through the “where” clause in a SQL statement to narrow down a database search.

Exemplary transaction rule 355 has database filter 360 describing qualifying operational events as all operational events pertaining to ER nurses, maternity nurses, and pediatric nurses. Transaction rule 355 determines that effective rate schedule 365 in rates table 80 is to be applied to the nurses during 2002.

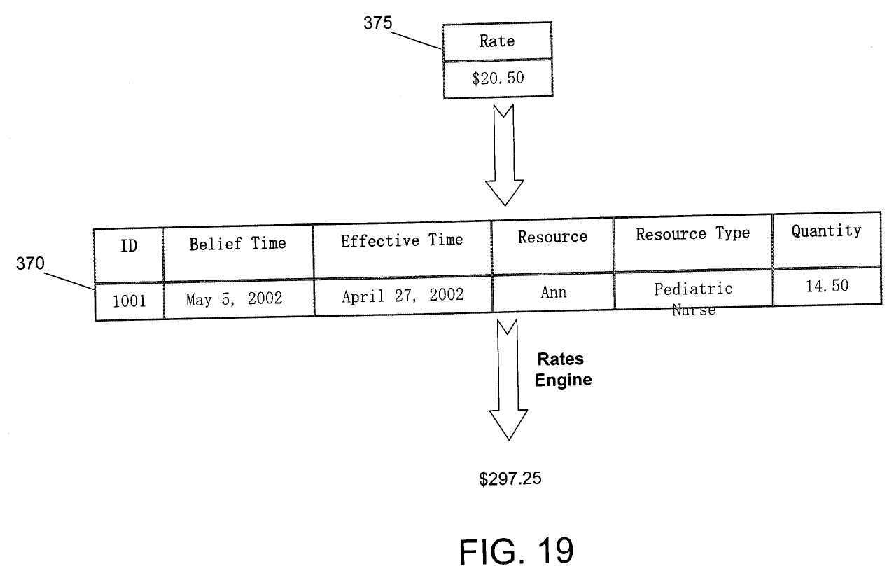

Referring now to FIG. 19, an illustrative diagram showing an exemplary transaction is described. Applying database filter 360 to operational events table 85 returns all operational events in operational events table 85 having ER nurses, maternity nurses, and pediatric nurses as values in resource type field 350e. For example, operational events table 85 may have a single operational event with a resource type matching a pediatric nurse such as operational event 370. Applying database filter 360 to operational events table 85 results in a transaction including operational event 370 and rate 375, which is the rate from effective rate schedule 365 in rates table 80 that matches the effective time of operational event 370. Rates engine 65 then applies rate 375 to operational event 370 to generate a dollar value for the wages due to Ann for that day.

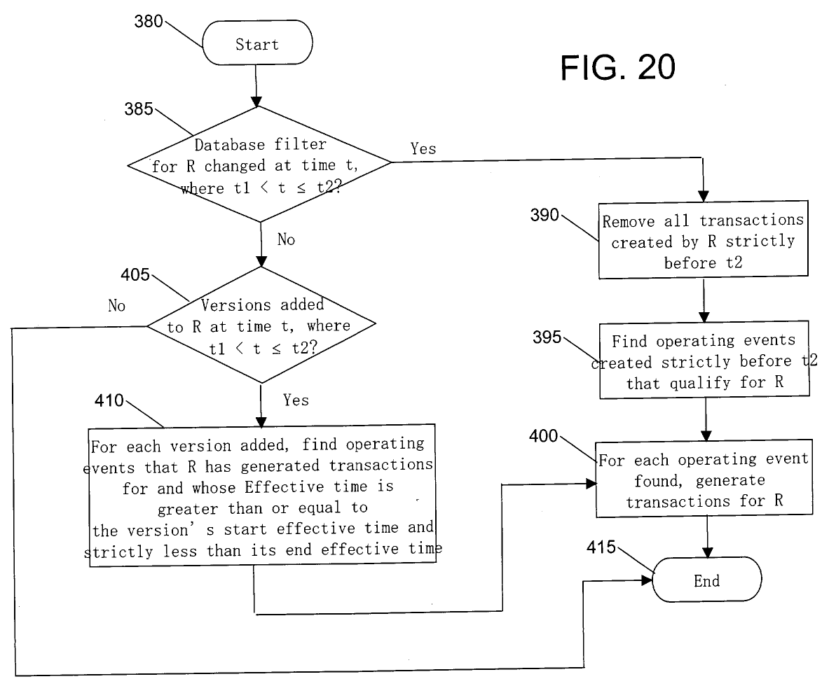

Referring now to FIG. 20, a flow chart for applying retroactive rates to existing transactions is described. A transaction rule R may be applied to operational events to process retroactive rate changes at any time t between t1 and t2, where t1 is strictly less than t2 and t1 represents the last time a retroactive rate change was performed and t2 represents the time at which the next retroactive rate change is to be performed. There are two cases to consider when applying a retroactive rate change: (1) the database filter corresponding to R has changed between t1 and t2; and (2) the effective rate schedule corresponding to R has changed between t1 and t2. Both cases result in a different transaction rule that needs to be applied retroactively to qualifying operational events.

In the first case, if the database filter for R has changed strictly after t1 and before or at t2 (385), then a retroactive rate change needs to be applied to all qualifying operational events that match the new transaction rule. That is, all transactions created by R before t2 need to be removed (390) and all operational events that match the new transaction rule need to be found (395). For each operational event found, a new transaction is generated (400). For example, rule R may be rule 355 (FIG. 18) but changed to apply to ER nurses only on Mar. 1, 2002. If rule R had applied to an operational event on Feb. 1, 2002, that listed a pediatric nurse as a resource type, all transactions generated by R for that operational event must be removed since a pediatric nurse is no longer a qualifying operational event under rule R. R must then be reapplied to all operational events to reflect the change.

In the second case, when the effective rate schedule for R has changed, one or more of the following conditions are met: (1) a new rate and effective date was added to the effective rate schedule after t1 and before or at t2; (2) an effective date was removed from the effective rate schedule after t1 and before or at t2; and (3) a rate was changed for an existing effective date after t1 and before or at t2. Either one of these conditions results in a new version being added to rates table 80. For every version that needs to be added to rates table 80 strictly after t1 and before or at t2, and whose end belief time is set to infinity (405), operational events that may be affected by the new effective rate schedule need to be found (410). These operational events are such that R has generated a transaction for each one of them and their effective times are greater than or equal to the added version's start effective time and strictly less than its end effective time. For each operational event found, a new transaction is then generated (400). For example, rule R may be rule 355 (FIG. 18) and the rate of $22.00 valid from Jan. 1, 2002 to Apr. 31, 2002 may be changed to $21.50. To reflect the rate change, all transactions generated by R for operational events effective between Jan. 1, 2002 to Apr. 31, 2002 have to be re-generated.

Although particular embodiments of the present invention have been described above in detail, it will be understood that this description is merely for purposes of illustration. Specific features of the invention are shown in some drawings and not in others, for purposes of convenience only, and any feature may be combined with other features in accordance with the invention. Steps of the described processes may be reordered or combined, and other steps may be included. Further variations will be apparent to one skilled in the art in light of this disclosure and such variations are intended to fall within the scope of the appended claims.

What is claimed is:

1. A method for storing a rate in a database, the method comprising:
storing a dollar value for the rate;
storing an effective time interval associated with the rate; and
storing a belief time interval for maintaining a history of the rate.

2. The method of claim 1, further comprising costing an operational event with the rate.

3. The method of claim 2, further comprising storing the operational event in the database.

4. The method of claim 3, wherein storing the operational event comprises storing operational data representing a business operation.

5. The method of claim 4, wherein storing operational data comprises representing the operational data using: a resource; a resource type; a quantity; an effective time; and a belief time.

6. The method of claim 5, wherein representing the operational data using an effective time comprises storing a time during which the business operation was performed.

7. The method of claim 5, wherein representing the operational data using a belief time comprises storing a time when the operational event was entered into the database.

8. The method of claim 1, wherein storing an effective time interval comprises storing a time interval during which the dollar value of the rate is effective.

9. The method of claim 1, wherein storing a belief time interval comprises storing a time interval during which the dollar value of the rate and the effective time interval are believed to be valid.

10. A method for costing an operational event against a rate schedule, wherein the rate schedule includes a plurality of rates and a plurality of effective times associated with the plurality of rates, the method comprising:
storing the rate schedule in a database using a plurality of versions;
storing the operational event in the database as a dated entry in the database;
providing a rule for specifying the rates from the plurality of rates that apply to the operational event;
matching the operational event against the rates from the plurality of rates that apply to the operational event; and
computing a dollar value for the operational event based on the rates from the plurality of rates that match the operational event.

11. The method of claim 10, wherein costing an operational event comprises storing operational data representing a business operation.

12. The method of claim 11, wherein storing operational data comprises representing the operational data using: a resource; a resource type; a quantity; an effective time; and a belief time.

13. The method of claim 12, wherein representing the operational data using an effective time comprises the time during which the business operation was performed.

14. The method of claim 12, wherein representing the operational data using a belief time comprises storing a time when the operational event was entered into the database.

15. The method of claim 10, wherein storing the rate schedule in the database using a plurality of versions comprises, for each version from the plurality of versions, storing: a belief time interval; an effective time interval; and a dollar value for each rate from the plurality of rates.

16. The method of claim 15, wherein storing an effective time interval comprises storing a time interval during which the dollar value of the rate is effective.

17. The method of claim-15, wherein storing a belief time interval comprises storing a time interval during which the dollar value of the rate and the effective time interval are believed to be valid.

18. The method of claim 10, wherein storing the operational event in the database as a dated entry in the database comprises associating a belief time to the operational event, the belief time representing a time when the operational event was stored in the database.

19. The method of claim 10, wherein providing a rule for specifying the rates comprises using a database filter for specifying a plurality of operational events in the database to which the rule applies.

20. The method of claim 10, wherein matching the operational event against the rates from the plurality of rates that apply to the operational event comprises:
applying the database filter to the database to extract the operational event from the database; and
determining the rates that are effective at the effective time of the operational event.

21. The method of claim 10, wherein computing a dollar value for the operational event comprises multiplying the rates that are effective at the effective time of the operational event by the quantity of the operational event.

22. The method of claim 10, further comprising applying the rates specified in the rule retroactively to a plurality of operational events in the database.

23. A system for costing an operational event against a rate schedule according to a transaction rule, wherein the rate schedule lists a plurality of rates and a plurality of effective times associated with the plurality of rates, the system comprising:
a database routine for storing the operational event, the rate schedule, and the transaction rule;
a transaction rules manager routine for specifying the transaction rule;
a data access interface for accessing the database; and
a rates engine for generating a dollar figure for the operational event according to the transaction rule.

24. The system of claim 23, wherein the operational event comprises operational data representing a business operation.

25. The system of claim 24, wherein the operational data comprises: a resource; a resource type; a quantity; an effective time; and a belief time.

26. The system of claim 25, wherein the effective time comprises the time during which the business operation was performed.

27. The system of claim 25, wherein the belief time comprises the time when the operational event was entered into the database.

28. The system of claim 23, wherein the database routine comprises:
a rate field for storing the dollar value of each rate from the plurality of rates;
an effective time field for storing an effective time interval associated to each rate from the plurality of rates; and
a belief time field for keeping a history of the rate schedule.

29. The system of claim 28, wherein the belief time field comprises a time interval during which the dollar value of the rate and the effective time interval are believed to be valid.

30. The system of claim 23, further comprising a database filter for specifying a plurality of operational events in the database to which the rule applies.

31. The system of claim 23, wherein the rates engine comprises a routine for matching the operational event against the rates from the plurality of rates that apply to the operational event.

32. The system of claim 23, wherein the rates engine further comprises a routine for applying the rates specified in the rule retroactively to a plurality of operational events in the database.
